(19) United States
(12) Patent Application Publication
(10) Pub. No.: US 2004/0098229 A1
(43) Pub. Date: May 20, 2004

(54) Efficient click-stream data collection

(76) Inventors: Brett Error, Orem, UT (US); Chris Error, Orem, UT (US)

Correspondence Address: FENWICK & WEST LLP, SILICON VALLEY CENTER, 801 CALIFORNIA STREET, MOUNTAIN VIEW, CA, 94041, US

(21) Appl. No.: 10/608,515

(22) Filed: Jun. 26, 2003

Related U.S. Application Data
(60) Provisional application No. 60/393,003, filed on Jun. 28, 2002.

(51) Int. Cl. G06F 11/30; G06F 15/00; G21C 17/00

(52) U.S. Cl. 702/186

(57) ABSTRACT

A client rendering a web page discovers embedded content directing the client to request embedded content from a data collection server. The data collection server performs a cookie handshake by determining whether the request includes a visitor identifier. If a visitor identifier is present, the request data is collected and categorized with the visitor identifier. If the visitor identifier is not present, the data collection server creates a visitor identifier and do not repeat flag and sends these items with a redirection request to the client, thereby establishing a visitor identifier for the redirected contact. Where the client does not accept visitor identifiers, or the visitor identifier otherwise is lost, the data collection server creates a visitor identifier based on the client's address, or some other available data.

### RELATED APPLICATIONS

This application claims priority under 35 U.S.C. § 119(e) to U.S. Provisional Application Serial No. 60/393,003, dated Jun. 28, 2002, entitled “Collecting Click-Stream of Users on a Website,” the contents of which are incorporated by reference. This application is related to U.S. patent application Ser. No. ______entitled “Custom Event and Attribute Generation for Use in Website Traffic Data Collection” (Atty Dkt. No. 7133) and U.S. patent application Ser. No. ______entitled “Capturing and Presenting Site Visitation Path Data” (Atty Dkt. No. 7131), both of which were filed on the same date as the present invention.

### TECHNICAL FIELD

This invention relates to tracking user traffic on websites, and more specifically, to an efficient method of collecting a website user's click-stream while visiting a website.

### BACKGROUND

One of the most common sales mantras is “know your customer.” This basic tenet of selling has grown far beyond knowing who enters the store; it requires among other things, knowing what attracts customers, what they look at, how they move around the store, and how long they stay. By studying customer buying habits, retailers have been able to maximize their revenues through tailoring their promotions, offerings and even store layouts to suit their customers' preferences and habits.

For bricks-and-mortar sellers of goods and services, gathering such data rapidly becomes cost-prohibitive. Identifying basic information about customer behavior at the check-out stand may be fairly cost-effective; but monitoring a customer's path through the store or how long customers spend selecting a particular product requires much more expensive monitoring. In contrast, such behavioral tracking in the on-line environment occurs without significant increases in cost, thus making complex data collection not only possible, but a requirement to remain competitive.

A common method of tracking the behavior of visitors to websites uses cookies. A cookie is a small file placed on a visitor's computer when the visitor first visits a website. As the visitor moves through the site, certain events, such as requesting another web page, are recorded and stored in the cookie. Upon the occurrence of a certain event, such as completing a transaction by checking out, the data collection server uploads the information from the cookie and stores that information in a database.

This common method suffers from several significant drawbacks. Because the tracking data is stored in the cookie itself, the size of the cookie file can become quite large, requiring unacceptable amounts of space on the visitor's computer. Moreover, transferring these large cookies can utilize large amounts of the bandwidth available to the user and the data collection system.

As a result of the large size, impact on bandwidth, and also for privacy reasons, many users block and/or delete these cookies. Other users employ programs to delete cookies at periodic intervals. When a user deletes a cookie, the entire history of the user's movement through the website is lost. If a cookie is deleted, no data collection is possible. Existing data collection systems treat the user's next visit to the website as if it is the user's first visit. Even though the same user is visiting the site multiple times, the data collection server treats the user as a new visitor on each subsequent visit.

A similar problem occurs when a user's client does not accept cookies. Existing data collection systems have no way of determining whether a client accepts or refuses cookies. If a client does not accept cookies, on subsequent visits to the same website, the data collection systems does not receive any cookie data. Even if the data collection system causes another cookie to be set on the user's computer, the data collection system treats the user as a new visitor to the website.

For these reasons, a need exists for an efficient method of collecting click-stream data without creating large, bandwidth-hogging cookies. Moreover, a need exists for a data collection system that can determine whether the client accepts cookies and can minimize the data loss resulting from deletion of cookies.

### SUMMARY OF THE INVENTION

The invention solves these problems by using a visitor identifier, such as a cookie. The visitor identifier may be persistent or may be set to expire upon the occurrence of an event or elapsed time period. The invention provides for the generation and placement of visitor identifiers at the client and also provides a back-up method of identification should the client not accept the visitor identifier. The invention further performs validation checks on the visitor identifier and categorizes the visitor identifier and associated data such as time and page viewed. The invention also determines when a user's session has ended; upon reaching the end of the session, it stores the session as a complete history of the user's use of the resources on a website.

The process of click-stream data collection begins when the user initially requests a resource from a website, such as a web page. As the user's client loads the web page, the client is directed to get other content embedded in the web page, such as a picture, from a data collection server. Upon receiving this request, the data collection server determines whether the request includes a visitor identifier. If a visitor identifier is present, the data collection server verifies that the visitor identifier is valid and places the visitor identifier and other associated data, such as a time stamp, page identifier, and any other data associated with the request, into a session list with other data for the same visitor identifier. Other associated data, such as a time stamp or page identifier, may be included in the request for the embedded content, or may be gathered and stored by the data collection server.

If the request does not include a visitor identifier, the data collection server assigns a unique visitor identifier and sends it back to the client along with a redirection request. In general, redirection requests indicate to the client rendering the web page that a requested resource can be found at an address other than the address of the original request. The present invention redirects the client back to the same address as the original request, forcing the client to contact the data collection server a second time, this time with the new visitor identifier the data collection server has just created and sent to the client.

Clients that do not accept visitor identifiers do not send visitor identifiers to the data collection system. In one embodiment, the data collection system recognizes that visitor identifiers are not being accepted or are otherwise not going to be available from a client, so as to avoid infinite repetition of the process of assigning a new visitor identifier, and sending a redirection request on each request from the client.

The redirection request also includes a “do not repeat” indicator along with the new visitor identifier. The “do not repeat” indicator allows the data collection server to recognize this refusal and avoid an endless loop. When the indicator is detected, the data collection server does not continue to try to send a new visitor identifier to the client, but instead creates a unique visitor identifier based on the client's address and a user-agent string. This visitor identifier is not sent to the client, but is used by the data collection server to identify the visitor when logging data related to the request. In this manner, collection of the visitor identifier and associated data continues, without disturbing the client.

At some point, the data collection server determines that the user's session has ended. This can occur when a fixed amount of time since the last client request has elapsed; or, the session can end upon the occurrence of some event, such as a user completing a purchase by visiting the check-out page. When the data collection server has determined that the session has ended, it stores the collected data detailing the user's historical use of the resources on the website. By ordering the requests for resources by time stamp, the user's movement through the site, or click-stream, can be reconstructed. This data can be reordered and manipulated by an analysis program to provide information about user behavior valuable to operators of websites.

The invention tracks the user's click-stream by collecting data sent by the user's client as the client requests resources on a website. It uses small, efficient visitor identifiers to identify specific users. Because the invention does not depend upon storing click-stream information in a cookie for later collection, the client is not required to store large cookies or transfer large amounts of cookie data. Accordingly, user and data collection server bandwidth are not adversely affected by the click-stream tracking.

Moreover, should the user delete his identifier during a session, all the data is not lost. The data collection system has already collected the click-stream data up to the time when the user deleted the visitor identifier. Additionally, the data collection system resumes collecting click-stream information from the point the visitor identifier was deleted. In this manner, data loss from deletion of the visitor identifier is minimized.

Furthermore, the present invention provides a data collection system that recognizes when a client does not accept visitor identifiers or cookies. Upon discovering a client that does not accept cookies, the data collection system can provide alternate methods of identifying the visitor without setting additional cookies or visitor identifiers at the client. The present invention can avoid endless loops and collect accurate data regarding new versus repeat visitors.

Further features of the invention, its nature and various advantages will be more apparent from the accompanying drawings and the following detailed description.

### BRIEF DESCRIPTION OF THE DRAWINGS

The accompanying drawings illustrate several embodiments of the invention and, together with the description, serve to explain the principles of the invention.

FIG. 1 is a block diagram illustrating one embodiment of the click-stream data collection system.

FIG. 2 is a flowchart illustrating the process of data collection of one embodiment of the click-stream data collection system.

### DETAILED DESCRIPTION OF THE EMBODIMENTS

The present invention is now described more fully with reference to the accompanying figures, in which several embodiments of the invention are shown. The present invention may be embodied in many different forms and should not be construed as limited to the embodiments set forth herein. Rather these embodiments are provided so that this disclosure will be thorough and complete and will fully convey the invention to those skilled in the art.

Generally, the present invention relates to the collection of click-stream data. Click-stream data documents the historic use of website resources by a user as the user navigates a website. For example, a user may navigate a website selling books in the following manner: First the user requests the top-level page for the website which presents some broad categories of books for sale. The user then selects one of the broad categories, causing the page for that category to be loaded. The user selects a particular book, which loads the page displaying more information about that book. If the user elects to purchase the book, the user selects a link to display the check-out page. Thus, the user's click-stream is as follows:

Top-level page ->category page ->book page ->check-out page

Many on-line retailers offer promotions that appear on other websites. In these cases, a user may not enter the site though the top-level page, but may arrive at the category or book level page through a referring site. In other cases, a user may visit several different category pages, then lose interest and leave the site. Website operators are interested in tracking this type of data to determine how to most effectively attract and retain visitor to their sites. By studying such data, website operators can determine which promotions are the most effective, and how to organize their sites to maximize certain results such as sales revenues, total traffic, or other metrics of interest.

Click-streams can be monitored by a website server itself, or a remote server, such as a data collection server. In order to facilitate monitoring by a remote data collection server, the data collection server is notified of activity on a website. One method of notifying the data collection server is by causing the client to request embedded content from the data collection server.

Embedded content is part of a web page, such as an image, that is requested as a separate file from the file containing the web page. The separate file may be requested from the server containing the website or from a remote server, such as a remote content server or data collection server. For example, when a user requests a web page from a website server, the website server sends the web page file to the user's client. The client, such as a web browser, then attempts to render the file as a viewable web page. However, upon rendering the web page file, the client may find a reference to a separate file located on the website server or a remote server. After the content is located and sent to the client, the client renders the separate file containing the embedded content along with the original web page.

A web bug is a particular type of embedded content where the content itself is irrelevant. For example, a web bug is often a 1 pixel by 1 pixel, clear image. This image is small enough to appear invisible to the user. However, when the client encounters the web bug upon rendering a web page, the client sends the request and additional information about the user and the user's environment to the server indicated by the web bug. The request can include the data from a cookie, or other information gathered as a result of the execution of a script that occurred when the web page was rendered. Where the server indicated by the web bug is a data collection server, the data collection server may set an additional cookie for identification for tracking purposes. In this manner, the web bug can be used to indicate to a data collection server that a particular web page is being rendered.

One method for including the request is to write the request as a static image tag in Hyper Text Markup Language (HTML). The following is an example of an image tag in HTML:

<img src=“http://ad.datacollectionserver.com/tracker.exe?AID=14658& PID=259294&banner=0.gif” width=1 height=1 border=0>

Here, the term “ad.datacollectionserver.com” refers to the address of the data collection server.

Another common method of including the request is to use a scripting language, such as JavaScript. One advantage of using a script instead of a static image tag is that the script can perform other functions including gathering additional data and sending it along with the request. In either case, the result is a request sent to the data collection server upon the occurrence of an event, such as the loading and rendering of a web page. Once the request has been sent to the data collection server, the data collection server can begin performing tracking functions.

A. Data Collection System Overview

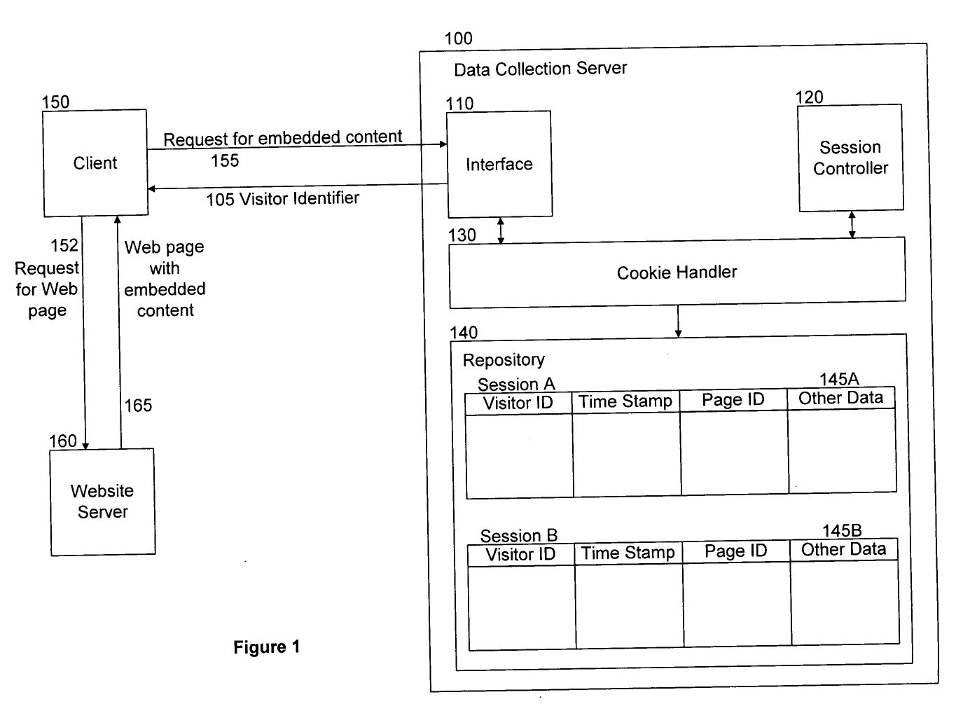

FIG. 1 is a block diagram illustrating one embodiment of the data collection system. The data collection system includes a data collection server 100, a client 150 and a website server 160. The client 150 communicates with the website server 160 via network-based connections and protocols for sending requests for web pages 152, and for receiving web pages 165. The client 150 communicates with the data collection server 100 via network-based connections and protocols for making requests for embedded content 155, and for receiving visitor identifiers and redirection requests 115.

The data collection server further includes an interface 110, a session controller 120, a cookie handler 130 and a repository 140. For illustration purposes, the repository 140 includes two sessions, session A 145A and session B 145B. More or fewer sessions may be included in alternative embodiments. The interface 110 sends and receives requests and identifiers to and from the client 150. The interface 110 provides a connection internal to the data collection server 100 to the cookie handler 130. The cookie handler is connected to the session controller 120 and the repository 140.

The data collection process begins when the client 150 makes a request for a web page from the web server 160 via the connection 152 to web server 160. The request may also be for a resource on the website other than a web page. For example, the request may be to download a particular file or document from the website server using a file transfer protocol. Where the request is for a web page, the web server 160 sends the web page with embedded content by the connection 165 to the client. The client 150 then renders the web page and discovers the embedded content, resulting in a request for embedded content to the data collection server 100 through connection 155.

The data collection server 100 receives the request for embedded content via the interface 110 and passes the request to the cookie handler 130. The cookie handler 130 records the request for embedded content in the repository 140. The repository 140 stores the requests by visitor identifier, time stamp and page identifier along with any other data received with the request. For example, a particular request may be recorded as follows:

TABLE 1

| Visitor | | | |
|---|---|---|---|
| Identifier | Time Stamp | Page Identifier | Other Data |
| visitor1234 | 12:08 pm, | www.booksales.com/page1 | vj3-7gpy-397 |
| | 5/2/2003 | | |

The visitor identifier, such as a cookie or other identifying object, is a unique identifier created by the cookie handler 130. The visitor identifier may be persistent or set to expire upon the occurrence of some event or elapsed time frame. Furthermore, the visitor identifier may include only a unique identifier, or may also include other data such as time stamp, page identifier and other data. The other data may be sent along with the request for the embedded content, or may be gathered and stored by the data collection system.

The visitor identifier may be sent to the client 150 via connection 105 for further communications with the data collection server 100 or may be assigned by the cookie handler 130 and recorded directly by the repository 140 along with the other request data. The time stamp may be assigned by the data collection server 100, or by the client 150 and passed to the data collection server along with the request. The page identifier indicates the website and resource that the client was rendering when the request was made. Other data may include a range of data, including but not limited to, identification of last page viewed by user, time spent viewing a particular page, custom-designed data strings, data from a transaction occurring on the website, and other data of interest to website operators.

The cookie handler 130 also communicates with the session controller 120 to determine if the user's session has ended. Several criteria can be used to determine whether a session has ended. One criterion may be the amount of time elapsing between page views. For example, after a certain amount of time has elapsed, the user may be assumed to have left the computer or shut down his client, having completed his session. The session controller 120 can then signal the cookie handler 130 that the user has likely completed his session.

Another method of determining the end of a session is to assign an end of session value to a particular event. Such an event may be, for example, when a user completes a purchase transaction by visiting the check-out page. Upon observing the request from the check-out page, the session controller can indicate to the cookie handler 130 that the session has completed.

Upon declaring the end of a user's session, the session controller 120 instructs the cookie handler 130 to store the requests collected as a session set, illustrated as session A 145A. A session stored in the repository may be organized, for example, as follows:

TABLE 2

| Visitor Identifier | Time Stamp | Page Identifier | Other Data |
|---|---|---|---|
| visitor1234 | 12:08:15 pm, 5/2/2003 | www.booksales.com/page1 | vj3-7gpy-397 |
| visitor1234 | 12:10:32 pm, 5/2/2003 | www.booksales.com/page2 | 2:17 |
| visitor1234 | 12:10:35 pm, 5/2/2003 | www.booksales.com/page1 | Fiction |
| visitor1234 | 12:11:51 pm, 5/2/2003 | www.booksales.com/page3 | scroll_down |
| visitor1234 | 12:12:18 pm, 5/2/2003 | booksales.com/checkout | $14.95 |

One method of ordering the data is to categorize each request and associated data by visitor identifier and list these entries in ascending order of time. Table 2 represents the click-stream of the user with visitor identifier “vistor 1234” as the user navigated the booksales.com website. Other methods of categorization and ordering may be used to achieve other storage efficiencies.

The click-stream data can be used by a data analysis program to analyze various patterns of user behavior. The data analysis program can categorize and order the data in any manner useful to website operator. In this manner, the click-stream data can be studied to determine the most effective website organization and promotional programs, among other things.

B. Cookie Handler Functional Description

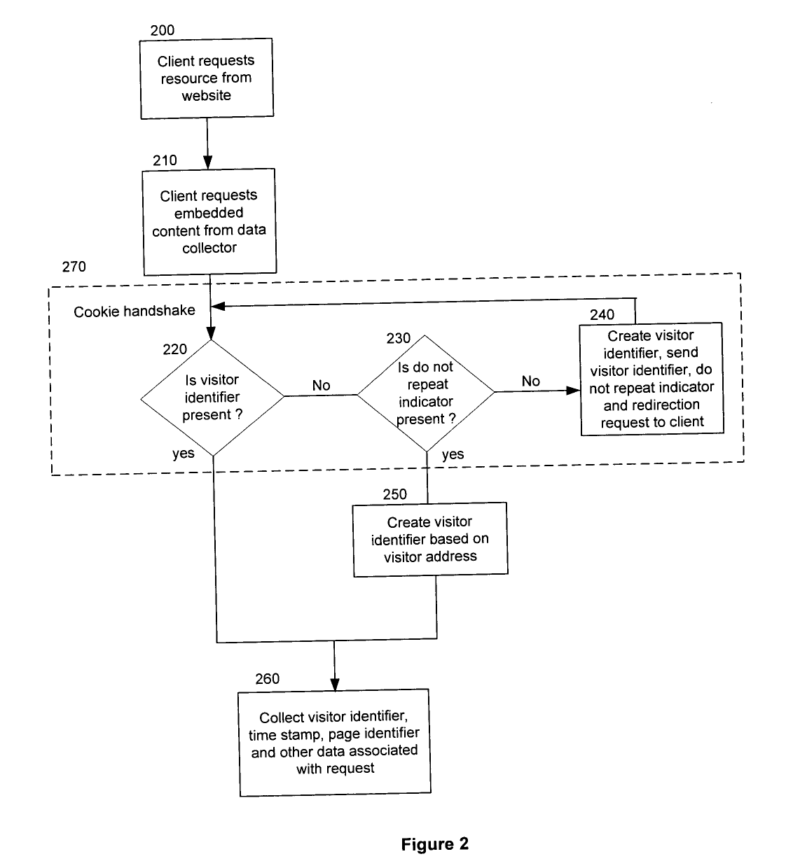

FIG. 2 depicts a flow chart illustrating the functioning of the data collection system according to one embodiment. The process begins when a client 150 requests a resource from a website 200. The website server 160 sends a web page including a pointer to embedded content such as a web bug. The client 150 then requests the embedded content from the data collection server 210. At this point, the data collection server 100 performs a series of steps collectively referred to as a cookie handshake 270. The cookie handshake 270 provides the data collection system with a method of determining whether a client accepts cookies, whether cookies information can reliably be sent from a client to the data collection systems, and provides an alternate method of identifying visitors when visitor identifiers are not received from the client.

The cookie handshake 270 includes several verification steps using the cookie handler 130. The cookie handler 130 determines whether the request includes a visitor identifier 220. This cookie handler may also determine whether the visitor identifier is a valid identifier by comparing it to the range of visitor identifiers normally created by the cookie handler 130. The visitor identifier may also be validated through the use of a hash algorithm or other method. If a visitor identifier is present, the cookie handler passes the visitor identifier, time stamp, page identifier, and other data associated with the request to the repository 260.

However, if the visitor identifier is missing or invalid, the cookie handshake process 270 continues by determining whether a “do not repeat” indicator is present 230. If the “do not repeat” indicator is not present, then the cookie handler 130 assigns a visitor identifier, sets the “do not repeat” indicator, and sends the visitor identifier, “do not repeat” indicator and a redirection request 240 to the client 150 via the interface 110. The redirection request indicates to the client that the embedded content the client is requesting can be found at a particular location. The location specified by the cookie handler 130 is the data collection server 100 itself. This redirection request causes the client 150 to repeat the request to the data collection server, but this time including the visitor identifier.

However, not all redirection requests will contain the visitor identifier assigned by the cookie handler. Some clients, for example, will not accept visitor identifiers and therefore will not send the visitor identifier assigned by the cookie handler. In other cases, the visitor identifiers may become corrupted or lost during transmission due to a poor connection. In these cases, in order to avoid an infinite loop in which visitor identifiers are repeatedly created and sent back to the client, the cookie handler 130 checks for the “do not repeat indicator” 230. If the “do not repeat” indicator is present, but the request does not include a visitor identifier, the cookie handler 130 recognizes that the either the client does not accept visitor identifiers, or the visitor identifier has become corrupt or lost. The cookie handler creates a visitor identifier based on the client's address 250, and collects the visitor identifier, time stamp, page identifier, and other data associated with the request 260. The client's address may include the client's address alone, or it may include the client's address in combination with a user-agent string or any other identifying data. These items may then be stored in the repository as a normal click-stream entry occurring with a visitor identifier created by the cookie handshake process 270.

The present invention achieves the collection of click-stream data by collecting the requests and associated data at the data collection server 100. In this manner, the invention uses small, efficient visitor identifiers, and avoids the need for large amounts of storage on the user's computer. Similarly, because large files are not being transferred back and forth between the client 150 and the data collection server 100, bandwidth is not unnecessarily wasted during the collection process. Furthermore, because click-stream data is collected at the data collection server, an interruption in the process, such as the deletion of the visitor identifier, does not render the entire click-stream useless. Rather, the data associated with the user's click-stream before the interruption occurred has already been collected at the data collection server for use in later analysis. Therefore, the effects of interruption are minimized.

In the above description, for purposes of explanation, numerous specific details are set forth in order to provide a thorough understanding of the invention. It will be apparent, however, to one skilled in the art that the invention can be practiced without these specific details. In other instances, structures and devices are shown in block diagram form in order to avoid obscuring the invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system's memories or registers or other such information storage, transmission or display devices.

The present invention also relates to an apparatus for performing the operations herein. This apparatus may be specially constructed for the required purposes, or it may comprise a general-purpose computer selectively activated or reconfigured by a computer program stored in the computer.

Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer, network of computers, or other apparatus. Various general-purpose systems may be used with programs in accordance with the teachings herein, or it may prove convenient to construct a more specialized apparatus to perform the required method steps. The required structure for a variety of these systems appears from the description. In addition, the present invention is not described with reference to any particular programming language. It will be appreciated that a variety of programming languages may be used to implement the teachings of the invention as described herein.

As will be understood by those familiar with the art, the invention may be embodied in other specific forms without departing from the spirit or essential characteristics thereof. For example, the particular architectures depicted above are merely exemplary of one implementation of the present invention. The functional elements and method steps described above are provided as illustrative examples of one technique for implementing the invention; one skilled in the art will recognize that many other implementations are possible without departing from the present invention as recited in the claims. Likewise, the particular capitalization or naming of the modules, protocols, features, attributes, or any other aspect is not mandatory or significant, and the mechanisms that implement the invention or its features may have different names or formats.

In addition, the present invention may be implemented as a method, process, user interface, computer program product, system, apparatus, or any combination thereof. Accordingly, the disclosure of the present invention is intended to be illustrative, but not limiting, of the scope of the invention, which is set forth in the following claims.

What is claimed is:

1. A method for tracking the use of resources on a website comprising the steps of:
a.) receiving a request for a resource;
b.) determining whether the request for the resource includes a visitor identifier;
c.) responsive to the request not including the visitor identifier:
assigning a new visitor identifier; and
sending a redirection request with the new visitor identifier to the client;
d.) categorizing data sent with the request for the resource; and
e.) repeating steps a-d until reaching a session expiration.

2. The method for tracking the use of resources on a website as in claim 1, wherein the visitor identifier comprises a cookie.

3. A method for tracking the use of resources on a website comprising the steps of:
a.) receiving a request for a resource from a requestor;
b.) determining whether the request for the resource included a do not repeat indicator;
c.) responsive to the request including the do not repeat indicator, assigning a visitor identifier from the requestor's address;
d.) categorizing data received with the request for the resource; and
e.) repeating steps a-d until reaching a session expiration.

4. The method for tracking the use of resources on a website as in claim 3, wherein the visitor identifier comprises a cookie.

5. The method for tracking the use of resources on a website of claim 1, wherein determining whether the request for the resource included a visitor identifier further comprises the steps of:
comparing the visitor identifier with a range of valid visitor identifiers; and,
in response to the visitor identifier being outside the range of valid visitor identifiers, indicating that the request did not include the visitor identifier.

6. The method for tracking the use of resources on a website as in claim 5, wherein the visitor identifier comprises a cookie.

7. The method for tracking the use of resources on a website of claim 1, wherein categorizing data received with the request for the resource comprises the steps of:
categorizing the data received with the request for the resource by at least one selected from the group consisting of a visitor identifier, a page identifier, and a time stamp.

8. The method for tracking the use of resources on a website as in claim 7, wherein the visitor identifier comprises a cookie.

9. The method for tracking the use of resources on a website of claim 1 or claim 2, wherein step e.) comprises:
repeating steps a-d for a predetermined amount of time.

10. The method for tracking the use of resources on a website of claim 1 or claim 2, wherein step e.) comprises:
repeating steps a-d until receiving a particular request for a resource.

11. A data collection server for tracking the use of resources on a website comprising:
a communication interface for receiving a request for a resource and sending a visitor identifier;
a cookie handler coupled to the communications interface for testing the request for the resource and assigning the visitor identifier;
a session controller coupled to the cookie handler for signaling the session end for a particular visitor identifier; and,
a repository for storing data sent with the request for the resource.

12. The method for tracking the use of resources on a website as in claim 11, wherein the visitor identifier comprises a cookie.

13. A data collection server for tracking the use of resources on a website of claim 7, where a cookie handler for testing the requested for the resource and creating the visitor identifier further comprises:
a means for sending a do not repeat indicator associated with the visitor identifier, coupled to the communication interface; and,
a means for checking whether the do not repeat indicator is present in the request for the resource, coupled to the communication interface.

14. A method for tracking the use of resources on a website comprising the steps of:
sending a request for a resource to a data collection server;
in response to the request not including a visitor identifier:
receiving a new visitor identifier and a redirection request from the data collection server;
sending the request for a resource with the new visitor identifier to the data collection server; and,
receiving the requested resource.

15. The method for tracking the use of resources on a website as in claim 14, wherein the visitor identifier comprises a cookie.

16. A method for tracking the use of resources on a website comprising the steps of:
sending a request for a resource to a data collection server;
in response to the request not including a visitor identifier:
receiving a do not repeat indicator and a redirection request from the data collection server;
sending the request for a resource with the do not repeat indicator to the data collection server; and,
receiving the requested resource.

17. The method for tracking the use of resources on a website as in claim 16, wherein the visitor identifier comprises a cookie.

18. One or more computer readable storage devices having computer readable code embodied on said computer readable storage devices, said computer readable code for programming one or more computers to perform a method for tracking the use of resources on a website comprising the steps of:
a.) receiving a request for a resource;
b.) determining whether the request for the resource includes a visitor identifier;
c.) responsive to the request not including the visitor identifier:
assigning a new visitor identifier; and
sending a redirection request with the new visitor identifier to the client;
d.) categorizing data sent with the request for the resource; and
e.) repeating steps a-d until reaching a session expiration.

19. One or more computer readable storage devices having computer readable code embodied on said computer readable storage devices, said computer readable code for programming one or more computers to perform a method for tracking the use of resources on a website comprising the steps of:
a.) receiving a request for a resource from a requester;
b.) determining whether the request for the resource included a do not repeat indicator;
c.) responsive to the request including the do not repeat indicator, assigning a visitor identifier from the requestor's address;
d.) categorizing data received with the request for the resource; and
e.) repeating steps a-d until reaching a session expiration.

20. One or more computer readable storage devices having computer readable code embodied on said computer readable storage devices, said computer readable code for programming one or more computers to perform the method for tracking the use of resources on a website as in claim 19, wherein the visitor identifier comprises a cookie.
